(19) United States
(12) Patent Application Publication
(10) Pub. No.: US 2020/0124921 A1
(43) Pub. Date: Apr. 23, 2020

(54) LIQUID CRYSTAL DISPLAY PANEL AND LIQUID CRYSTAL DISPLAY

(71) Applicant: Bo Hai, Huizhou Guangdong (CN)

(72) Inventor: Bo Hai, Huizhou Guangdong (CN)

(21) Appl. No.: 15/748,684

(22) PCT Filed: Jan. 23, 2018
(86) PCT No.: PCT/CN2018/073686

§ 371 Date: Jan. 30, 2018

(30) Foreign Application Priority Data
Dec. 12, 2017 (CN) 201711336019.3

(51) Int. Cl. G02F 1/13363

(52) U.S. Cl. CPC G02F 1/133634; G02F 2202/28; G02F 2413/12

(57) ABSTRACT

The present application relates to a liquid crystal display panel and a liquid crystal display. The liquid crystal display panel includes a first polarizer and a second polarizer opposite to each other. A vertically aligned liquid crystal cell is disposed between the first polarizer and the second polarizer; the liquid crystal display panel further comprises: an optical biaxial compensation films. This disclosure unilaterally uses the optical biaxial compensation film to compensate the light leakage of the side view so as to maintain the contrast of the side view of the liquid crystal panel and reduce the thickness of the polarizer.

### RELATED APPLICATIONS

The present application is a National Phase of International Application Number PCT/CN2018/073686, filed Jan. 23, 2018, and claims the priority of China Application 201711336019.3, filed Dec. 12, 2017.

### FIELD OF THE DISCLOSURE

The present application relates to the field of liquid crystal display technology, and in particular, to a liquid crystal display panel and a liquid crystal display.

### BACKGROUND

A vertically aligned cell (VA cell) is a commonly used liquid crystal cell structure of a display, and refers to a display mode in which liquid crystal molecules are vertically aligned with a substrate. Vertically aligned display mode with its wide viewing angle, high contrast and alignment no need for friction and other advantages of, as large-size LCD panel commonly used display mode.

Please refer to FIG. 1, which is a schematic diagram of an optical biaxial compensation film in the prior art for a vertical alignment mode. The liquid crystal panel in the vertical alignment display mode includes a first protective layer 121, a first polarizer 122, a first biaxial optical compensation film 123, a first pressure sensitive adhesive layer 124, a vertically aligned liquid crystal cell 110, the second pressure sensitive adhesive layer 134, the second biaxial optical compensation film 133, the second polarizer 132 and the second protective layer 131. The absorption axis of the first polarizer 122 is set at 0 degree and the slow axis of the first biaxial optical compensation film 123 is set at 90 degrees with respect to the 0 degree direction of the horizontal viewing angle of the liquid crystal cell 110 vertically aligned. The slow axis of the shaft compensation film 133 is set at 0 degree, and the absorption axis of the second polarizer 132 is set at 90 degrees. Since the optical biaxial compensation film has the in-plane compensation value Ro and the out-of-plane compensation value Rth in the thickness direction. The variation of the slow axis of the compensation film causes the polarization state of the incident light to change, thereby the brightness of the emergent light and causing light leakage is affected in the dark state. For such light leakage, the in-plane phase difference Ro generally needs to be used to compensation.

Ro and Rth and defined as follows:

Ro=(Nx−Ny)*d

Rth=[(Nx+Ny)/2−Nz]*d

Ro is defined as the in-plane retardation caused by light passing through the compensation film; and Rth is defined as the retardation in the out-of-plane thickness direction of light generated by the compensation film.

Where Nx and Ny are the in-plane refractive indices of the compensation film in the horizontal direction, Nz is the vertical refractive index of the compensation film in the vertical direction, and d is the compensation film thickness.

At present there are two major industry vertical alignment liquid crystal display panel, respectively Color Filter on Array (COA) formula and a liquid crystal panel (Normal) ordinary liquid crystal display panel, the structure shown in FIGS. 2 and 3 shows both a vertical alignment liquid crystal display panel comprises: 120, a color filter substrate 111, liquid crystal layer 112, a color filter 113, a thin film transistor (TFT) substrate 114, the first polarizer and a second polarizer 130. The difference is that in a COA liquid crystal display panel, a color filter 113 of a liquid crystal layer 110a is located between a liquid crystal layer 112 and a thin film transistor 114. In the common liquid crystal display panel 112, a color filter 113 in the liquid crystal layer 110b is between a liquid crystal layer 112 and the color filter substrate 111. Compared with the conventional liquid crystal display panel, the technology can effectively integrate the color filter and the thin film transistor substrate to improve the pixel aperture ratio and the display quality of the liquid crystal panel. The polarizer generally includes an outer protective layer, a polarizer, and a pressure sensitive adhesive layer affixed with the liquid crystal cell. The design of the polarizer directly determines the display quality of the liquid crystal display panel.

Therefore, in order to solve the technical problem of “how to improve the contrast of the liquid crystal display panel by adjusting the setting of the polarizer”, the solutions of the present invention are proposed for the different structures of two vertically aligned liquid crystal display panels.

### SUMMARY

An object of the present application is to provide a liquid crystal display panel capable of reducing light leakage in a dark state, further improving contrast, and being thin and light.

In order to solve the above technical problem, a technical solution adopted by the present application is: a liquid crystal display panel, comprising: a first polarizer and a second polarizer disposed oppositely; vertically aligned liquid crystal cells disposed between the first polarizer and the second polarizer, characterized by further comprising: an optical biaxial compensation film, one side of the optical biaxial compensation film disposed between the first polarizer or the second polarizer and the vertically aligned liquid crystal cells;

an absorption axis of the first polarizer is disposed at a first angle, an absorption axis of the second polarizer is disposed at a second angle, and the optical biaxial compensation film is disposed at a third angle based on 0 degree direction of horizontal viewing angle of the vertically aligned liquid crystal cell; the first angle and the second angle are different and are one of 90 degrees or 0 degree; with respect to the vertically aligned liquid crystal cell, the third angle and angles of the first and second polarizers on a side opposite to the optical biaxial compensation films are the same.

In order to solve the above problem, another technical solution adopted by the present application is: a liquid crystal display panel, comprising: a first polarizer and a second polarizer disposed oppositely to each other; a vertically aligned liquid crystal cell disposed between the first polarizer and the second polarizer, characterized by further comprising: an optical biaxial compensation film, disposed between one side of the first polarizer or the second polarizer and the vertical alignment liquid crystal cell.

In order to solve the above problem, another technical solution adopted by the present application is: a liquid crystal display comprising a liquid crystal display panel and a backlight module arranged oppositely, the backlight module providing a display light source to the liquid crystal display panel. The liquid crystal display panel comprises: a first polarizer and a second polarizer disposed oppositely to each other; the absorption axis of the first polarizer is disposed at a first angle based on the zero degree horizontal direction of the vertical aligned liquid crystal cells, and the absorption axis of the second polarizer is disposed at a second angle, the optical biaxial compensation film is disposed at a third angle; the first angle and the second angle are different from each other and are one of 90 degrees or zero degrees; in the vertically aligned liquid crystal cells, the third angle and angles of the first and second polarizers on the sides opposite to the optical biaxial compensation films are the same.

The beneficial effects of the present application are as follows: {1} different from the prior art, the liquid crystal display panel and the liquid crystal display proposed in the present application compensate for the light leakage in the side view by using an optical biaxial compensation film on one side to keep the contrast of side view of the liquid crystal panel; further, the vertical aligned liquid crystal cell uses a single side of the zero phase retardation film, which can effectively reduce the optical biaxial compensation film due to the light leakage in dark state, thereby the contrast of liquid crystal panels is enhanced, while water vapor is effectively able to isolate and the polarizing plate is supported by the core layer of the polarizer. The zero phase compensation film on the shaft angle is not required, so you can reduce the precision requirements of slow axis of compensation film material for the polarizer and the precision requirements of the bonding of the polarizer. The over whole cost of the polarizer is reduced. Further, through the improvement of the polarizer material and the removal of zero-phase retardation film, the present disclosure has the mentioned contrast, and the thin thickness of the polarizer reduces stress and improves the warpage problem of the large-size LCD panel.

### BRIEF DESCRIPTION OF THE DRAWINGS

FIG. 1 is a schematic structural view of an existing liquid crystal panel in the present application;

FIG. 2 is a schematic diagram of the structure of the existing color filter integrated liquid crystal display panel of the present application;

FIG. 3 is a schematic structural view of the conventional liquid crystal display panel of the present application;

FIG. 4 is a schematic structural view of a liquid crystal display panel of the first embodiment of the present application;

FIG. 5 is a schematic diagram of the contrast of the polarizer with the compensation value Ro in the first embodiment of the present application;

FIG. 6 is a schematic view of a contrast in the polarizer with a compensation value Rth curve according to the first embodiment of the present application are;

FIG. 7 is a schematic diagram of dark state light leakage distribution when Ro=0 nm in the first embodiment of the present application;

FIG. 8 is a first embodiment of the present application in schematic Ro dark state light leakage distribution=144 nm;

FIG. 9 is a schematic diagram of the maximum value of the side view light leakage as a function of Ro in the first embodiment of the present application;

FIG. 10 is a schematic structural view of a liquid crystal display panel according to a second embodiment of the present application;

FIG. 11 is a schematic view of a third embodiment of the panel of the liquid crystal display of the present application;

FIG. 12 is a schematic structural view of a liquid crystal display panel of the fourth embodiment of the present application;

FIG. 13 is the application of the same model with different compensation film polarizing film orthogonal spectrum diagram;

FIG. 14 is a schematic structural diagram of an embodiment of a liquid crystal display in the present application.

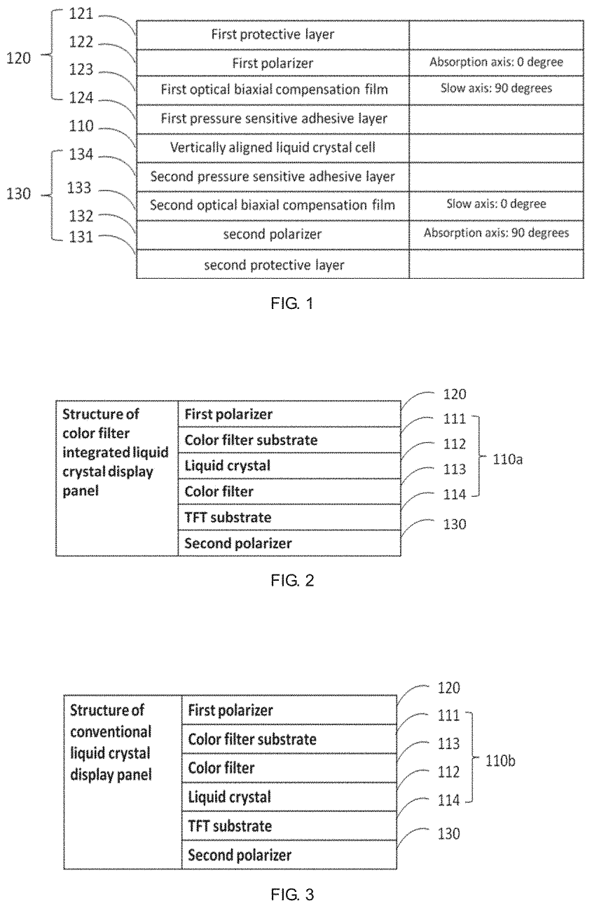

### DETAILED DESCRIPTION OF PREFERRED EMBODIMENTS

The technical solutions in the embodiments of the present invention will be described clearly and completely hereinafter with reference to the accompanying drawings. Apparently, the described embodiments are merely a part but not all embodiments of the present invention. All other embodiments obtained by a person of ordinary skill in the art based on the embodiments of the present invention without creative efforts shall fall within the protection scope of the present invention.

It should be noted that directional terms such as “up” “down”, “front”, “back”, “left”, “right”, “inside”, “outside”, “side” and the like are merely referring to the attached drawings. The directional terms used are used to better and more clearly illustrate and understand the present application, rather than indicating or implying that the device or component to be referred to must have a specific orientation, Constructed and operated in a particular orientation, and therefore should not be construed as limiting the present application.

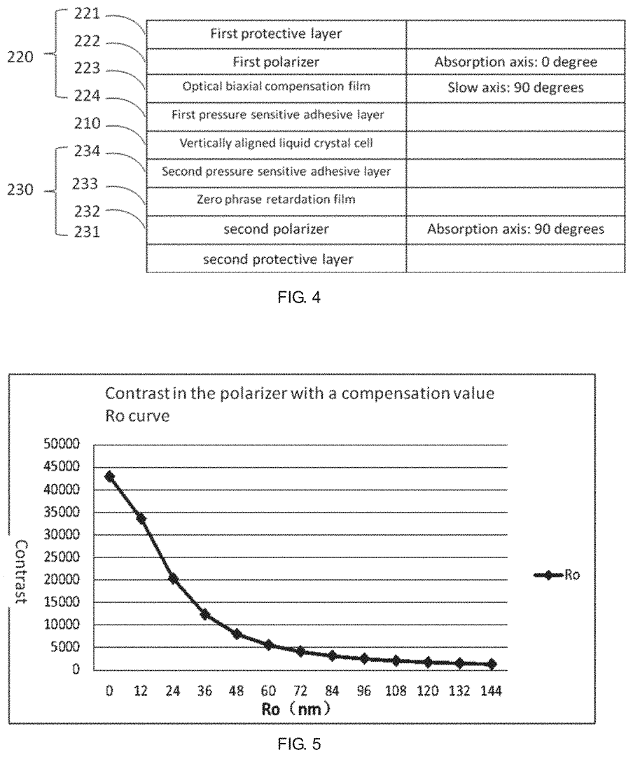

First, for the existing color filter integrated liquid crystal display panel, the following improvements is made by the present application are as follows. Referring to FIG. 4, a first embodiment of the present application is shown. Examples of the liquid crystal display panel according to the present embodiment includes: a vertical alignment liquid crystal cell 210 as the center. a first protective layer 221 is arranged sequentially from top to bottom, and the material is a triacetate cellulose (TAO), Polyethylene terephthalate (PET), or polymethyl methacrylate (PIMA). The protective layer is used for protecting the polarizer and isolating water vapor. At the same time, it can support the whole polarizing plate. The first polarizer 222 is polyvinyl alcohol (PVA) film, and a core layer of the polarizer containing a polarizer and an analyzer. A biaxial optical compensation film 223, and a compensation film liquid crystal mode is used with a compensation value Ro and Rth. The compensation film is used to compensate light leakage of large viewing angle and color shift, while the play isolated water vapor, supporting the role of a polarizer; a first pressure sensitive adhesive (PSA) layer 224. A polypropylene plastic is typically used as a binder to adhesive the polarizer to glass. A vertical aligned liquid crystal cell 210, a second pressure sensitive adhesive layer 234, a zero phase retardation film 233, a second polarizer 232 and a second protective layer 231.

Further, in this embodiment, the polarizer on the side opposite to the optical biaxial compensation film 223 is the second polarizer 232, and then the zero phrase retardation film 233 is disposed between the vertically aligned liquid crystal cell 210 and the second polarizer 232.

In this embodiment, the optical biaxial compensation film 223 is disposed between the first polarizer 222 and the vertically aligned liquid crystal cell 210. Since the vertical aligned liquid crystal cell 210 is one transistor structure integrated a chip with the a color filter. In conjunction with FIG. 2, in particular a vertical alignment liquid crystal cell structure 110a can be seen. The color filter 113 and the optical biaxial compensation film 223 of the present embodiment are located on both sides of the liquid crystal layer 112, and the biaxial compensation film 223 is located above the liquid crystal layer 112, and the color filter 113 is located below the liquid crystal layer 112.

Further, the absorption axis of the first polarizer 222 is disposed at a first angle, the absorption axis of the second polarizer 232 is disposed at a second angle; the optical biaxial compensation film 223 is disposed at a third angle. The first angle and the second angle are different and the same as one of 90 degrees or 0 degree. Compared with the vertical alignment liquid crystal cell 210, the third angle corresponds to the angle of the polarizer on the side opposite to the optical biaxial compensation film 223. In this embodiment, the polarizer on the side opposite to the optical biaxial compensation film is the second polarizer 232. Therefore, the third angle and the second angle are the same.

In particular, continued reference to FIG. 4, a vertically aligned liquid crystal cell 210 in the horizontal viewing angle 0 degree direction as a reference, each film layer is disposed at an angle which the absorption axis of the first polarizer 222 was 0 degree, the slow axis of the optical biaxial compensation film 223 was 90 degrees, the absorption axis of the second polarizer 232 is 90 degrees; and the absorption axis of the first polarizer 222 is 90 degrees, the slow axis of the optical biaxial compensation film 223 was 0 degree, the absorption axis of the second polarizer is 0 degrees. It can be seen that the second polarizer 232 and the optical biaxial compensation film 233 are located on a side of the vertical alignment liquid crystal cell 210, and therefore the angle of the slow axis of the optical biaxial compensation film 223 and the angled phase of the second polarizer 232 are the same. In the present embodiment, the optical biaxial compensation film 23 is used on one side of the vertically aligned liquid crystal cell 210 to compensate the light leakage in the side view so as to maintain the contrast of the side view of the liquid crystal panel.

Further, the retardation value Ro of the internal phase of the optical biaxial compensation film in this embodiment is 144 to 408 nm. Next, the basis for selecting the range of the internal phase difference Ro between the optical biaxial compensation films will be described.

In general, compensation principle of the compensation film is generally to correct the phase difference of the liquid crystal at different angles, so that the birefringence properties of the liquid crystal obtain symmetry compensation. The optical biaxial compensation film has an in plane retardation Ro and an out-of-plane retardation Rth in the thickness direction.

In the actual polarizer production process, the slow axis of the compensation film material will fluctuate and will not be stable at 0 degree or 90 degree. The general specification is ±0.5 degree. The variation of the slow axis of the compensation film will cause the incident light changes in polarization, thus the brightness of the emitted light is affected, resulting in dark state light leakage and affecting the contrast.

When the slow axis of the compensation film deviates from 1 degree, LCD master simulates the influence of the different compensation values Ro and Rth to the light leakage in the dark state and the contrast through the use of the liquid crystal display simulation software.

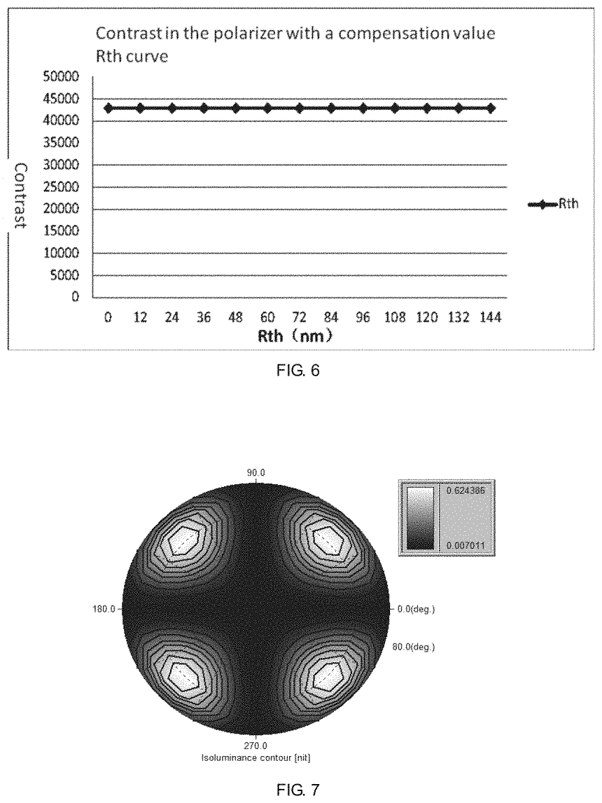

FIG. 5 and FIG. 6, respectively, for the polarizer contrast compensation Ro and Rth trends. It can be seen that under the condition that the angle of the slow axis of the compensation film is 1 degree, the brightness of the dark state of the frontal vision gradually increases with the compensation value Ro increasing, and the positive contrast gradually decreases. As the compensation value Rth increases, the dark state of the brightness is fixed, and the contrast of the frontal vision is unchanged.

In the influence factors of the contrast of the polarizing plate resulting from the variation of the slow axis of the compensation film, only the in-plane phase difference Ro affects the contrast, and Rth does not affect the contrast. Therefore, the most direct way to enhance the contrast of the frontal view is to change the commonly used optical biaxial compensation film into a single axis compensation film having only the thickness direction surface position compensation value Rth for solving the problem of a decrease in contrast due to a slow-axis variation. But there is no in-plane phase difference. The non-orthogonal state caused by the dark state light leakage cannot be compensated when looking into the side of the polarizer.

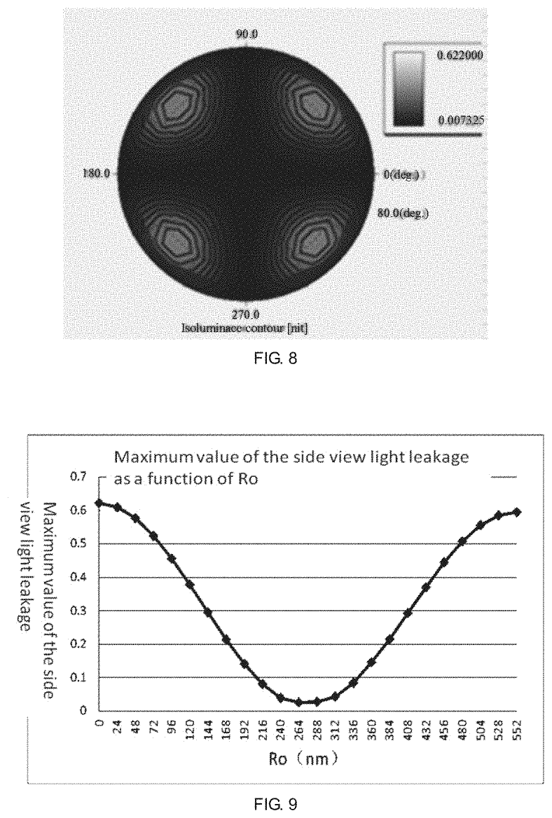

FIG. 7 and FIG. 8 show the side-view light leakage distributions at Ro=0 nm and Ro=144 nm respectively. It can be seen: when the face value of phase retardation Ro=0 nm, light leakage of the side view in the dark state is severe. When the value of the phase retardation Ro=144 nm, light leakage of the side view in the dark state has been very slight.

Further, it can be seen from FIG. 9 that the in-plane phase difference Ro can effectively reduce the light leakage caused by the non-orthogonal polarizer in side view. When Ro is in the range of 144-408 nm, the maximum lateral light leakage is within the acceptable range.

In the present application, the zero retardation film, values of the compensating film compensation Ro and Rth are both 0 and mainly functions to isolate the water vapor and to support the polarizer. The currently used zero retardation film has a cycloolefin polymer (Cyclo-olefin polymer, COP) membrane and TAO membrane. It should be noticed that in the present application, there is no requirement on the axial angle of the zero-phase retardation film, which can reduce the precision requirement of the slow axis of the polarizer compensation film material and the precision requirement when bonding with the polarizer, and reduce the overall cost of the polarizing plate.

Different from the prior art, a liquid crystal display panel proposed by the present disclosure compensates the light leakage of the side view by adopting a optical biaxial compensation film on one side so as to maintain the contrast of the side view of the liquid crystal panel. Further, the vertical alignment liquid crystal cell uses the zero phase difference film in one side, so that the present invention can effectively reduce due to the variation of the optical biaxial compensation film variation caused by the light leakage of the dark state and then enhance the contrast of the liquid crystal panel, while the water vapor is able to be effectively isolated, the core polarizer supports the polarizing plate. The angle of the zero phase film to the axis is not required, so the present disclosure can reduce the precision requirement of the slow axis of the polarizer compensation film material and the precision requirement when bonding with the polarizer, and reduce the overall cost of the polarizing plate.

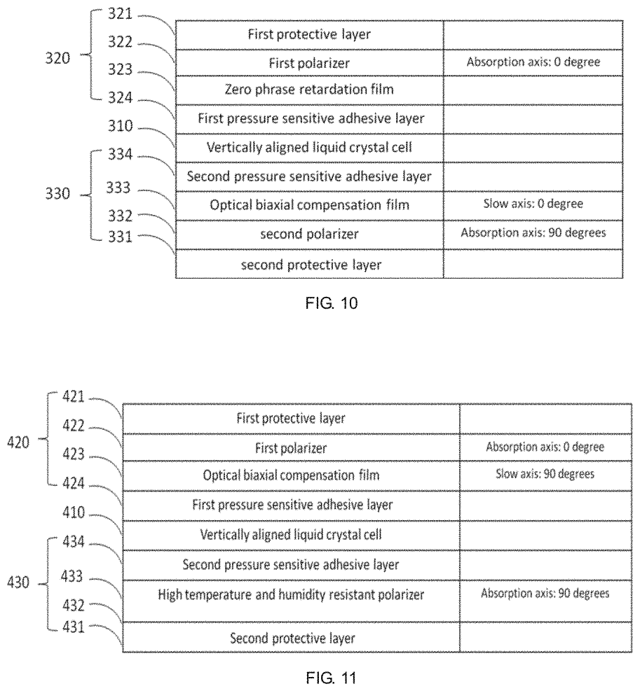

Next, for the conventional LCD panel, the present application made the following improvements: Please refer to FIG. 10, which is a second embodiment of the present application. Examples of the liquid crystal display panel according to the present embodiment comprise a vertical aligned liquid crystal cell 310 as the center. From top to bottom in this order, a first protective layer 321, the first polarizer 322, the zero phase difference film 323, a first pressure sensitive adhesive layer 324, a vertical alignment liquid crystal cell 310, a second pressure sensitive adhesive layer 334, a biaxial optical compensation film 333, a second polarizer 332 and a second protection layer 331 are disposed.

In this embodiment, the optical biaxial compensation film 333 is disposed between the second polarizer 332 and the vertical alignment liquid crystal cell 310. Due to the vertical alignment of the liquid crystal cell 310 is a conventional liquid crystal structure. It can be seen from the specific structure of the vertically aligned liquid crystal cell 110b in FIG. 3 that the color filter 113 and the optical biaxial compensation film 333 in this embodiment are located on both sides of the liquid crystal layer 112, and the optical biaxial compensation film 333 is located below the liquid crystal layer 112, and the color filter 113 is located above the liquid crystal layer 112.

Further, the absorption axis of the first polarizer 322 is disposed at a first angle; the absorption axis of the second polarizer 332 is disposed at a second angle; the biaxial optical compensation film 333 is disposed at a third angle. The first angle and the second angle are the same as one of 90° or 0°. The third angle is the same as angle of the polarizer on the side opposite to the biaxial optical compensation film 333 with respect to the vertical alignment of the vertically aligned liquid crystal cell 210. In this embodiment, the polarizer on the side opposite to the biaxial optical compensation film 333 is the second polarizer 332. Therefore, the third angle is same as the second angle.

Specifically, Please refer to FIG. 10, the vertically aligned liquid crystal cell 310 in the 0 degree of a horizontal viewing direction as a reference, and each film layer is disposed at an angle: the absorption axis of the first polarizer 322 was 0 degree. The slow axis of the compensation film 333 was 0 degree. The absorption axis of the second polarizer 332 is 90 degrees. The absorption axis of the first polarizer 322 is 90 degrees. The slow axis of the optical biaxial compensation film 333 is 90 degrees. The absorption axis of the second polarizer 332 is 0 degree. It can be seen that the first polarizer 322 and the optical biaxial compensation film 333 are located on sides opposite to the vertically aligned liquid crystal cell 310, Therefore, angle of the slow axis of the biaxial optical compensation film 333 and the angled phase of the first polarizer 322 are the same. In the present embodiment, an optical biaxial compensation film is used on one side relative to the vertically aligned liquid crystal cell 310 to compensate the light leakage of the side view so as to maintain the contrast of the side view of the liquid crystal panel.

Further, in this embodiment, the polarizer on the side opposite to the optical biaxial compensation film 333 is the first polarizer 322, and then the zero phase retardation film 323 is disposed between the vertical aligned liquid crystal cell 310 and the first polarization layer 322.

The embodiment adjusts two polarizers in the conventional liquid crystal cell structure correspondingly. Compared with the first embodiment of the present application, the difference is the position between the zero phase retardation film and the optical biaxial compensation film relative to the vertical aligned liquid crystal cell 310, but other structures have not changed.

Different from the prior art, a liquid crystal display panel proposed by the present application compensates the light leakage of the side view by adopting a biaxial optical axis compensation film on one side so as to maintain the contrast of the side view of the liquid crystal panel. Further, the zero phase difference film is used in one side of the vertical alignment liquid crystal cell, so that the dark state light leakage can be effectively reduced due to compensation film optical axis variation. Thereby, the contrast of the liquid crystal panel is enhanced while water vapor can be effectively isolated and the polarizer is supported by the core layer of the polarizer. The zero phase retardation film does not restrict the axis angle, so the slow axis of compensation film of the polarizer material requirements and the precision requirements of the polarizer can be reduced. The overall cost of the polarizer can be reduced.

Further, with the development of new materials, the zero phrase retardation film can be directly removed by using a water resistant, high-temperature resistant and wet polarizing material when a polarizer or a pressure-sensitive adhesive layer have reliable water resistance and supporting function. This zero phase retardation film has the phase difference of the film itself will not affect the deviation of the panel contrast, and can improve the stability of the panel contrast. At the same time, the thickness of the polarizer is reduced, the stress is weakened, and the warpage problem of the large size liquid crystal panel is improved.

For this reason, for the existing color filter integrated liquid crystal display panel, the improvements made by the present application are as follows. Referring to FIG. 11, there is a third embodiment of the liquid crystal display panel proposed in the present application.

In the present embodiment of a liquid crystal display panel, the difference from the first embodiment is the polarizer 432 on the side opposite to the biaxial optical compensation film 423 is available for high temperature and humidity. The material is a polyvinyl alcohol film with High temperature and humidity characteristics. The temperature and humidity resistant material property of the high temperature and humidity resistant polarizer 432 can achieve high temperature and humidity resistance by adjusting the formulation, draw ratio and tensile rate of the polyvinyl alcohol iodine solution. In this way, the monolithic polarizer has the characteristics of high temperature and humidity resistance. Specifically, the step of determining the polarizer with high temperature and humidity steps: for high temperature resistance characteristics, the specification of 40*40 mm is taken as a polarizing sample, with a roller attached to a clean glass, and placed at 80° C.*5 kgf/cm2 environment. After 15 minutes, to determine if 80° C., 500 hours of high temperature resistance requirement meets the specification. For high moisture resistance characteristics, the specification of 40*40 mm polarizer sample is taken, with a roller attached to the clean glass. The polarizing sample is placed in 80° C.*5 kgf/cm2 environment after 15 minutes to determine the 60° C., 90% RH (humidity). 500 hours of humidity resistance meets the specifications, which determine the specifications for the change of the polarizing single body penetration rate ≤5%.

Further, in the present embodiment, the zero phrase retardation film 233 in the first embodiment is directly removed. This is because the high temperature and wet resistant polarizer 432 is used to improve the material property of the polarizer on the one side with respect to the vertically aligned liquid crystal cell 410. The biaxial optical compensation film 423 is provided on the other side. Therefore, the material properties of a polarizer 422 are not limited. Other structures have not changed.

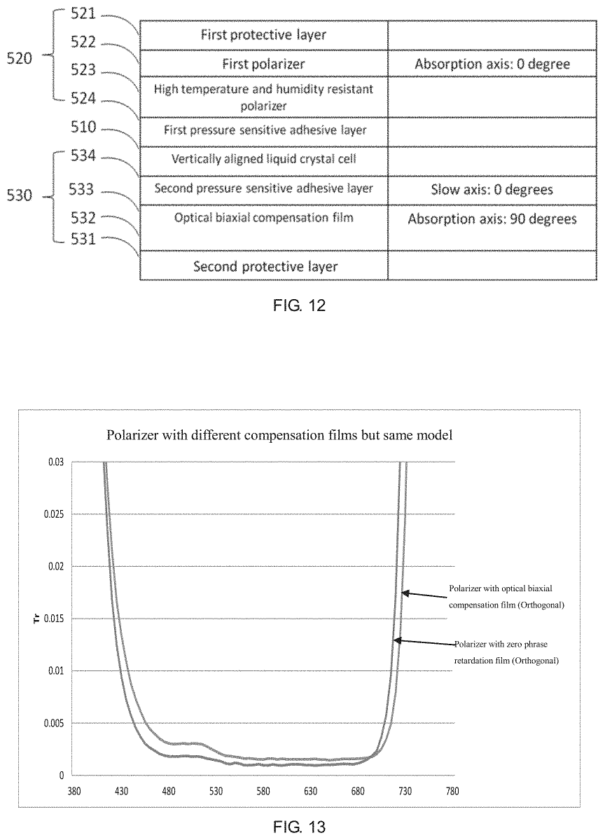

Please refer to FIG. 12, which is a fourth embodiment of the liquid crystal display panel proposed by the present application.

The difference of the second embodiment is that in a liquid crystal display panel, the polarizer on the side opposite to the biaxial optical compensation film 533 in the embodiment is a high temperature and wet resistant polarizer 522. The material is also a polyvinyl alcohol film with high temperature and humidity characteristics. The temperature and humidity resistant material properties of the high temperature and humidity resistant polarizer 522 can achieve high temperature and humidity resistance by adjusting the formulation, draw ratio and draw rate of the polyvinyl alcohol iodine solution. In this way, the monolithic polarizer has the characteristics of high temperature and humidity resistance. Specifically, the step of determining that the polarizer has high temperature and humidity resistance is as described above, and details are not described herein again.

Further, in the present embodiment, the zero phrase retardation film 323 in the second embodiment is directly removed. This is because the high temperature and wet resistant polarizer 522 is used to enhance the material properties of the polarizer on the one side with respect to the vertical aligned liquid crystal cell 510 and the optical biaxial compensation film 533 is provided on the other side. Therefore, the material properties of the second polarizer 532 are not limited. Other structures have not changed.

Further, the structure in the present application is verified below.

Please refer to FIG. 13, an orthogonal spectrum of the different compensation film is used to measure the same model. The orthogonal spectrum is the spectrum of the dark state when the upper and lower polarizer are vertical. The spectrum of the polarizing plate in dark state using the zero phrase retardation film was significantly lower than the spectrum of polarizing plate using the biaxial optical compensation film so the polarizing plate in dark state using the zero phrase retardation film has lower brightness and higher contrast. Because there is zero phase difference film or not, the phase difference is always 0. The figure shows that the use of zero phase retardation film can improve contrast and verify the contrast enhancement of the proposed structure of the application. Further, due to the use of high temperature and humidity polarizing materials, the zero phase retardation film can be solved while the zero phase retardation film can be supported and the contrast enhancement effect is consistent.

Further, the parallel transmittance of the polarizer is obtained by the actual measurement. The vertical transmittance and the contrast of the polarizer are as follows:

| | Zero phrase | Optical biaxial |
|---|---|---|
| | retardation layer | compensation layer |
| parallel | 42.96 | 42.97 |
| transmittance | | |
| vertical | 0.001201 | 0.001698 |
| transmittance | | |
| Contrast of | 35770 | 25306 |
| polarizer | | |

It can be clearly seen that the contrast ratio of the polarizer with the zero retardation film is obviously improved while the other parameters are not changed much. The increase of the contrast ratio of the polarizer to the liquid crystal panel will weaken the light leakage of the dark state, thereby increasing the contrast of the liquid crystal panel.

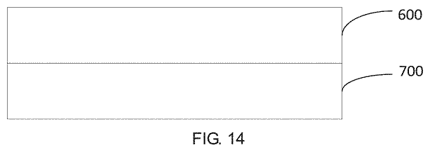

Please refer to FIG. 14, which is an embodiment of a liquid crystal display proposed by the present application.

A liquid crystal display includes a liquid crystal display panel 600 and a backlight module 700 disposed opposite to each other. The backlight module 700 provides a display light source to the liquid crystal display panel 600. The liquid crystal display panel 600 is any liquid crystal display panel in the embodiments of the present application.

It should be noted that the embodiment of the present application only improve two kinds of different structures of vertically aligned liquid crystal cells. It can be understood that any other type of liquid crystal cell structure can be used as long as the related structures in this application are used within the scope of the present application.

To sum up, in view of the current demand for high-contrast liquid crystal panels, the present invention develops a new polarizer architecture that takes into account both frontal contrast and side-view contrast without sacrificing side-view contrast and side-view taste panel production, yield under the premise of improving the compensation structure of the polarizer, and with the structure of the LCD cell to improve the contrast of the LCD panel, while eliminating material precision requirements of slow axis of the monolayer polarizer compensation film and the polarizer paste reducing the overall cost of the polarizer; and for the new polarizer architecture features, through the use of high durability polarized light to reduce the use of a layer of compensation film, thereby the thickness of the polarizer is reduce and the stress is reduced and the warpage problem of large-size liquid crystal panels is improved.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A liquid crystal display panel, comprising:
a first polarizer and a second polarizer disposed oppositely;
a vertically aligned liquid crystal cell disposed between the first polarizer and the second polarizer, characterized by further comprising:
an optical biaxial compensation film, one side of the optical biaxial compensation film disposed between the first polarizer or the second polarizer and the vertically aligned liquid crystal cell;
an absorption axis of the first polarizer is disposed at a first angle, an absorption axis of the second polarizer is disposed at a second angle, and the optical biaxial compensation film is disposed at a third angle based on 0 degree direction of horizontal viewing angle of the vertically aligned liquid crystal cell; the first angle and the second angle are different and are one of 90 degrees or 0 degree; with respect to the vertically aligned liquid crystal cell, the third angle and angles of the polarizers on a side opposite to the optical biaxial compensation films are the same.

2. The liquid crystal display panel according to claim 1, wherein the polarizers on the side opposite to the optical biaxial compensation film are polyvinyl alcohol films.

3. The liquid crystal display panel according to claim 1, wherein a zero-phase retardation film is provided between the polarizers on the side opposite to the optical biaxial compensation film and the vertically aligned liquid crystal cells, and the zero-phrase retardation film is used to isolate water vapor and support the polarizer.

4. The liquid crystal display panel according to claim 1, wherein the liquid crystal display panel further comprises a first pressure sensitive adhesive layer and a second pressure sensitive adhesive layer respectively attached on two surfaces of the vertically aligned liquid crystal cell.

5. The liquid crystal display panel according to claim 4, wherein the first pressure sensitive adhesive layer and the second pressure sensitive adhesive layer are both polypropylene-based adhesives.

6. The liquid crystal display panel according to claim 1, wherein a first protection layer and a second protection layer are further disposed respectively on outer sides of the first polarizer and the second polarizer with respect to the vertically aligned liquid crystal cell for supporting and protecting the first polarizer and the second polarizer.

7. The liquid crystal display panel according to claim 6, wherein the first protective layer and the second protective layer are any one of triacetylcellulose films, polymethylmethacrylate, or polyethyleneterephthalate alcohol ester.

8. A liquid crystal display panel, comprising:
a first polarizer and a second polarizer disposed oppositely to each other;
a vertically aligned liquid crystal cell disposed between the first polarizer and the second polarizer, characterized by further comprising:
an optical biaxial compensation film, disposed between one side of the first polarizer or the second polarizer and the vertical alignment liquid crystal cell.

9. The liquid crystal display panel according to claim 8, wherein the absorption axis of the first polarizer is disposed at a first angle, the absorption axis of the second polarizer is disposed at a second angle, and the optical biaxial compensation film is disposed at a third angle based on 0 degree of horizontal viewing angle of the vertically aligned liquid crystal cell; the first angle and the second angle are different from each other and are one of 90 degrees or 0 degree; in the vertically aligned liquid crystal cells, the third angle and angles of the polarizers on a side opposite to the optical biaxial compensation film are the same

10. The liquid crystal display panel according to claim 8, wherein the polarizers on a side opposite to the optical biaxial compensation film are polyvinyl alcohol films.

11. The liquid crystal display panel according to claim 8, wherein a zero-phase retardation film is provided between the polarizers on a side opposite to the optical biaxial compensation film and the vertically aligned liquid crystal cell, and the zero-phrase retardation film is used to isolate water vapor and support the first and second polarizer.

12. The liquid crystal display panel according to claim 8, wherein the liquid crystal display panel further comprises a first pressure sensitive adhesive layer and a second pressure sensitive adhesive layer respectively attached on two surfaces of the vertically aligned liquid crystal cell.

13. The liquid crystal display panel according to 12, wherein the first pressure sensitive adhesive layer and the second pressure sensitive adhesive layer are both polypropylene-based adhesives.

14. The liquid crystal display panel according to claim 8, wherein a first protection layer and a second protection layer are further disposed respectively on outer sides of the first polarizer and the second polarizer with respect to the vertically aligned liquid crystal cell for supporting and protecting the first polarizer and the second polarizer.

15. The liquid crystal display panel according to claim 14, wherein the first protective layer and the second protective layer are any one of triacetylcellulose films, polymethylmethacrylate, or polyethyleneterephthalate alcohol ester.

16. A liquid crystal display comprises a liquid crystal display panel and a backlight module arranged opposite to each other, the backlight module providing a display light source to the liquid crystal display panel, the liquid crystal display panel comprising:
a first polarizer and a second polarizer disposed oppositely to each other;
a vertically aligned liquid crystal cell disposed between the first polarizer and the second polarizer, characterized by further comprising:
an optical biaxial compensation film, disposed between one side of the first polarizer or the second polarizer and the vertically aligned liquid crystal cell;
the absorption axis of the first polarizer is disposed at a first angle, the absorption axis of the second polarizer is disposed at a second angle, and the optical biaxial compensation film is disposed at a third angle based on 0 degree of horizontal viewing angle of the vertically aligned liquid crystal cell; the first angle and the second angle are different from each other and are one of 90 degree or 0 degrees; in the vertically aligned liquid crystal cells, the third angle and angles of the polarizers on a side opposite to the biaxial optical compensation films are the same.

17. The liquid crystal display panel according to claim 16, wherein the polarizers on the side opposite to the optical biaxial compensation film is a polyvinyl alcohol film.

18. The liquid crystal display panel according to claim 16, wherein a zero phase retardation film is provided between the polarizers on the side opposite to the optical biaxial compensation film and the vertically aligned liquid crystal cell, and the zero phrase retardation film is used to isolate water vapor and support the first and second polarizers.

19. The liquid crystal display panel according to claim 16, wherein the liquid crystal display panel further comprises a first pressure sensitive adhesive layer and a second pressure sensitive adhesive layer respectively attached on two surfaces of the vertically aligned liquid crystal cell; the first pressure sensitive adhesive layer and the second pressure sensitive adhesive layer are both polypropylene based adhesives.

20. The liquid crystal display panel according to claim 16, wherein a first protection layer and a second protection layer are further disposed respectively on outer sides of the first polarizer and the second polarizer with respect to the vertically align liquid crystal cell for supporting and protecting the first polarizer and the second polarizer; the first protective layer and the second protective layer are any one of triacetylcellulose films, polymethylmethacrylate, or polyethyleneterephthalate alcohol ester.
